(19) United States
(12) Patent Application Publication
(10) Pub. No.: US 2023/0091305 A1
(43) Pub. Date: Mar. 23, 2023

(54) TOP COVER ASSEMBLY FOR BATTERY, BATTERY, AND ENERGY STORAGE DEVICE

(71) Applicant: Xiamen Hithium Energy Storage Technology Co., Ltd., Xiamen (CN)

(72) Inventors: Weidong Xu, Xiamen (CN); Nan Zhang, Xiamen (CN); Ziqi Yl, Xiamen (CN); Zuyu Wu, Xiamen (CN)

(73) Assignee: Xiamen Hithium Energy Storage Technology Co., Ltd., Xiamen (CN)

(21) Appl. No.: 17/951,743

(22) Filed: Sep. 23, 2022

(30) Foreign Application Priority Data
Sep. 23, 2021 (CN) 202122308051.9

(51) Int. Cl. H01M 50/533; H01M 50/152

(52) U.S. Cl. CPC H01M 50/533; H01M 50/152

(57) ABSTRACT

A top cover assembly for a battery, a battery, and an energy storage device are provided in the disclosure. The top cover assembly includes a pole and a current collector having multiple folding sections. The multiple folding sections include at least a first folding section and a second folding section. The first folding section is spaced apart from the second folding section in a length direction of the current collector. The current collector is divided by the first folding section and the second folding section into a first part, a second part, and a third part. The first part is bent toward one side of the second part and connected with the pole. The third part is bent toward the other side of the second part and connected with a wound core of the battery.

### CROSS-REFERENCE TO RELATED APPLICATION(S)

This application claims priority under 35 U.S.C. § 119(a) to and the benefit of Chinese Patent Application Serial No. 202122308051.9, filed Sep. 23, 2021, the entire disclosure of which is hereby incorporated by reference.

### TECHNICAL FIELD

This disclosure relates to the technical field of batteries, and in particular, to a top cover assembly for a battery, a battery, and an energy storage device.

### BACKGROUND

With the development of society, the aggravation of environmental pollution, and the depletion of traditional energy sources, people are becoming more and more aware of environmental protection. Lithium-ion batteries have become the first choice of green energy because of their high energy density, high voltage, low discharge rate, and long cycle life, and are therefore widely used in portable devices such as Bluetooth headsets, cell phones, digital cameras, and tablet computers, as well as large devices such as electric vehicles and energy storage power plants.

In comparison, when assembling a cover assembly of a cylindrical battery, a current collector connected between a tab and a pole is prone to be damaged due to processes such as welding.

### SUMMARY

The disclosure aims to solve at least one of technical problems in related art. To this end, a top cover assembly for a battery is provided in the disclosure.

A battery is also provided in the disclosure. The battery includes the above-mentioned top cover assembly for a battery.

An energy storage device is also provided in the disclosure. The energy storage device includes multiple above-mentioned batteries.

The top cover assembly for a battery according to the disclosure includes a pole and a current collector having multiple folding sections. The multiple folding sections include at least a first folding section and a second folding section. The first folding section is spaced apart from the second folding section in a length direction of the current collector. The current collector is divided by the first folding section and the second folding section into a first part, a second part, and a third part. The first part is bent toward one side of the second part and connected with the pole. The third part is bent toward the other side of the second part and connected with a wound core of the battery.

In the top cover assembly for a battery according to implementations of the disclosure, when folding the current collector, the current collector is folded in two different directions, so that the first part and the third part can be separated by the second part. As such, when welding the first part with the pole, influence of a welding process on the third part can be reduced. Similarly, when welding the third part with a tab of a battery core, influence of a welding process on the first part can also be reduced.

In some implementations, at least one of the first folding section or the second folding section extends straight.

In some implementations, the first part has a length larger than the second part in the length direction of the current collector.

In some implementations, the top cover assembly for a battery further includes an insulating cover plate, a top cover plate, and an insulating member. The insulating cover plate defines a mounting hole. The top cover plate is stacked with the insulating cover plate and defines a through hole. The through hole is opposite to the mounting hole and has a diameter smaller than the mounting hole. The insulating member is stacked with one side of the top cover plate away from the insulating cover plate. The insulating member defines a positioning hole. The positioning hole is opposite to the through hole and has a diameter smaller than the through hole.

In some implementations, the top cover assembly for a battery further includes a pressing block. The pressing block is disposed on one side of the insulating member away from the top cover plate. The pressing block defines a limiting hole opposite to the positioning hole.

The pole has a main body, a first flange, and a second flange. The first flange is located at an edge of one end of the main body, projects radially from the main body, and extends in a circumferential direction of the main body. The second flange is located at an edge of the other end of the main body, projects radially from the main body, and extends in the circumferential direction of the main body.

The limiting hole has a first hole section, a second hole section, and a third hole section which communicate in sequence. The first hole section has a radial size larger than the second hole section. The first flange is received in the second hole section. Part of the main body is received in the third hole section.

In some implementations, the pressing block has a fitting protrusion on one side of the pressing block facing towards the insulating member. The insulating member defines a fitting recess on one side of the insulating member facing towards the pressing block. The fitting protrusion is embedded in the fitting recess.

In some implementations, a height of the fitting protrusion extending from a surface of the pressing block is H₁, and a depth of the fitting recess is H₂, wherein H₁>H₂.

In some implementations, the top cover assembly for a battery further includes a top cover plate stacked with the insulating cover plate. The top cover plate defines an anti-rotation recess. The through hole is defined in the anti-rotation recess.

The insulating member has an anti-rotation flange on a circumferential wall of the insulating member. The anti-rotation flange is embedded in the anti-rotation recess.

A battery according to the implementations of the disclosure includes the above-mentioned top cover assembly for a battery.

In the battery according to the implementations of the disclosure, when folding the current collector, the current collector is folded in two different directions, so that the first part and the third part can be separated by the second part. As such, when welding the first part with the pole, influence of a welding process on the third part can be reduced. Similarly, when welding the third part with a tab of a battery core, influence of a welding process on the first part can also be reduced.

An energy storage device according to the implementations of the disclosure includes multiple above-mentioned batteries.

In the energy storage device according to the implementations of the disclosure, when folding the current collector, the current collector is folded in two different directions, so that the first part and the third part can be separated by the second part. As such, when welding the first part with the pole, influence of a welding process on the third part can be reduced. Similarly, when welding the third part with a tab of a battery core, influence of a welding process on the first part can also be reduced.

### BRIEF DESCRIPTION OF THE DRAWINGS

The above and/or additional aspects and advantages of the disclosure will become clear and better appreciated from implementations described in conjunction with the following accompanying drawings, wherein:

FIG. 1 is a top view of a top cover assembly for a battery according to implementations of the disclosure.

FIG. 2 is a cross-sectional view in direction A-A in FIG. 1.

FIG. 3 is a partial schematic structural view in FIG. 2.

FIG. 4 is a partial enlarged schematic view at circle B in FIG. 3.

FIG. 5 is a partial structural schematic view in FIG. 2, with a pole omitted.

FIG. 6 is a partial enlarged schematic view at circle C in FIG. 5.

FIG. 7 is a top view of a top cover assembly for a battery according to implementations of the disclosure.

FIG. 8 is an isometric view of a top cover assembly for a battery according to implementations of the disclosure.

FIG. 9 is an exploded view of a top cover assembly for a battery according to implementations of the disclosure.

FIG. 10 is a schematic cross-sectional view of a pole in FIG. 9.

FIG. 11 is an isometric view of a pressing block in FIG. 9 from one view.

FIG. 12 is an isometric view of the pressing block in FIG. 9 from another view.

FIG. 13 is a schematic cross-sectional view of the pressing block in FIG. 9.

FIG. 14 is an isometric view of an insulating member in FIG. 9 from one view.

FIG. 15 is an isometric view of an insulating member in FIG. 9 from another view.

FIG. 16 is a top view of the insulating member in FIG. 9.

FIG. 17 is a cross-sectional view of the insulating member in FIG. 9.

FIG. 18 is an isometric view of an insulating cover plate in FIG. 9 from one view.

FIG. 19 is an isometric view of the insulating cover plate in FIG. 9 from another view.

FIG. 20 is a top view of the insulating cover plate in FIG. 9.

FIG. 21 is a cross-sectional view of the insulating cover plate in FIG. 9.

FIG. 22 is a partial structural schematic view of the insulating cover plate in FIG. 21.

FIG. 23 is a schematic view of an assembly of the insulating cover plate and a current collector in FIG. 9.

FIG. 24 is a cross-sectional view in direction F-F in FIG. 23.

FIG. 25 is an isometric view of a top cover plate in FIG. 9 from one view.

FIG. 26 is a top view of the top cover plate in FIG. 9.

FIG. 27 is an isometric view of the top cover plate in FIG. 9 from another view.

FIG. 28 is a top view of the current collector in FIG. 9, the current collector is in a deployed state.

FIG. 29 is a schematic structural view of the current collector in FIG. 9, the current collector is in a folded state.

FIG. 30 is a schematic structural view of the current collector in FIG. 9, the current collector is in a folded state.

FIG. 31 is a schematic structural view of a battery according to implementations of the disclosure.

FIG. 32 is a schematic structural view of an energy storage device according to implementations of the disclosure.

### REFERENCE SIGNS

top cover assembly: 100; insulating cover plate: 110; mounting hole: 111; limiting rib: 112; first limiting rib: 113; second limiting rib: 114; third limiting rib: 115; reinforcing rib: 116; abutment portion: 117; protective flange: 118; bending edge: 119; top cover plate: 120; through hole: 121; anti-rotation recess: 122; insulating member: 130; positioning hole: 131; boss: 132; second chamfer: 133; third chamfer: 134; fitting recess: 135; anti-rotation flange: 136; first anti-rotation edge: 137; second anti-rotation edge: 138; pressing block: 140; limiting hole: 141; first chamfer: 142; first hole section: 143; second hole section: 144; third hole section: 145; fitting protrusion: 146; pole: 150; main body: 151; first flange: 152; second flange: 153; sealing cavity: 154; gap: 155; sealing member: 156; current collector: 160; first folding section: 161; first groove: 1611; second folding section: 162; second groove: 1621; first part: 163; second part: 164; third part: 165; enlarged section: 166; avoidance gap: 167; avoidance hole: 168; explosion-proof hole: 170; explosion-proof valve: 171; liquid-injection hole: 172; liquid-injection hole plug: 173; battery: 1000; case: 200; energy storage device: 2000; housing: 2200; opening: 157; battery core: 400.

### DETAILED DESCRIPTION

Exemplary implementations of the disclosure will be described in detail hereinafter with reference to the accompanying drawings.

In the implementations of the disclosure, terms such as “center”, “longitudinal”, “lateral”, “length”, “width”, “thickness”, “on”, “under”, “front”, “back”, “left”, “right”, “vertical”, “horizontal”, “top”, “bottom”, “in”, “out”, “clockwise”, “anticlockwise”, “axial”, “radial”, “circumferential” referred to herein which indicate directional relationship or positional relationship are directional relationship or positional relationship based on accompanying drawings and are only for the convenience of description and simplicity, rather than explicitly or implicitly indicate that apparatuses or components referred to herein must have a certain direction or be configured or operated in a certain direction and therefore cannot be understood as limitation on the disclosure.

In addition, terms “first”, “second”, and the like are only used for description and cannot be understood as explicitly or implicitly indicating relative importance or implicitly indicating the number of technical features referred to herein. Therefore, features restricted by terms “first”, “second”, and the like can explicitly or implicitly include at least one of the features. In the context of the disclosure, unless stated otherwise, “multiple” refers to “at least two”, such as two, three, and the like.

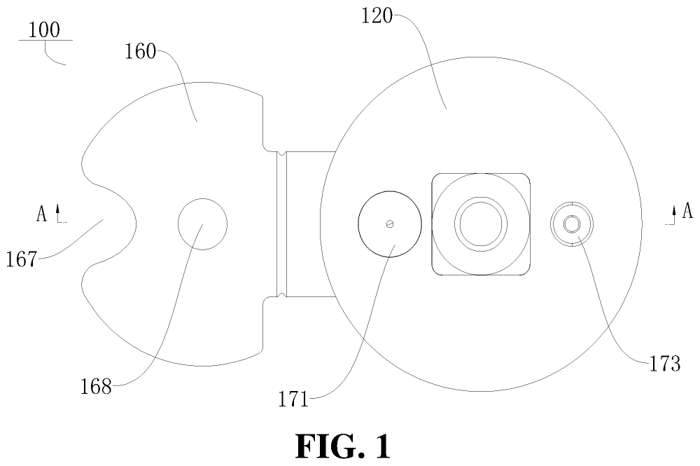

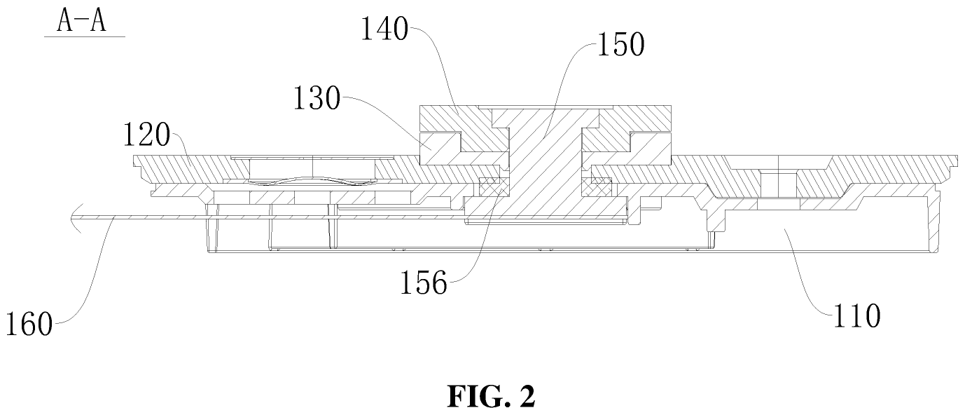

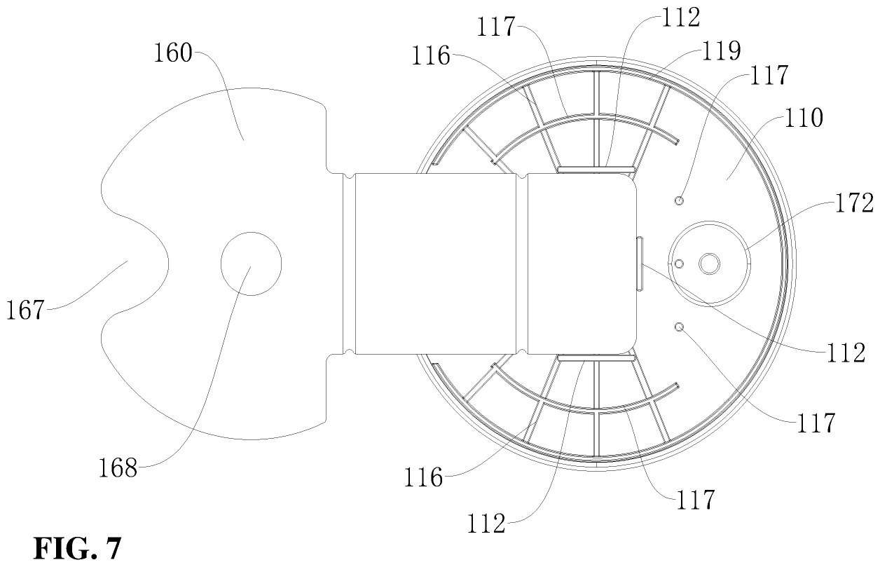

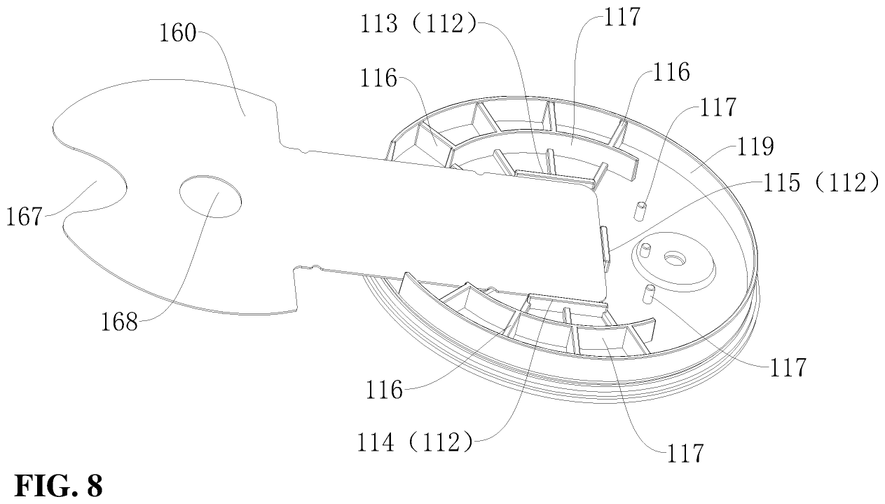

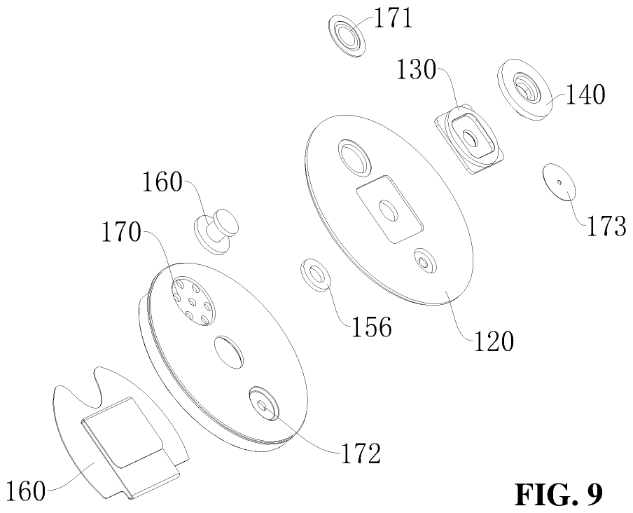

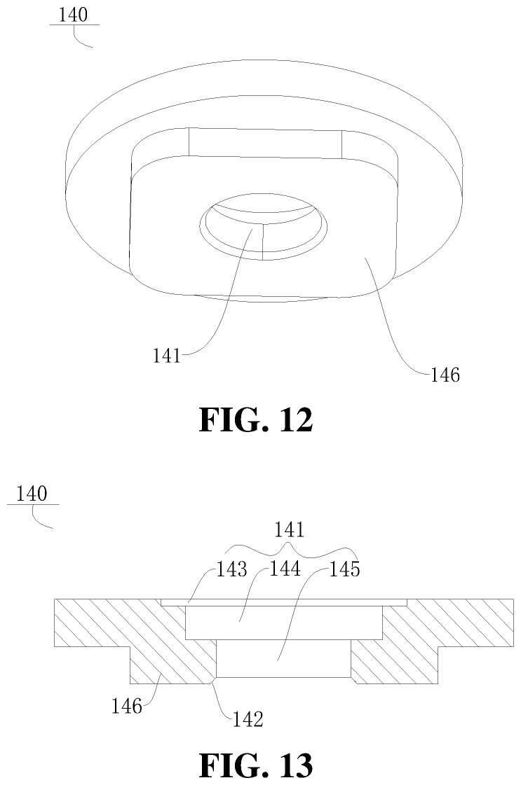

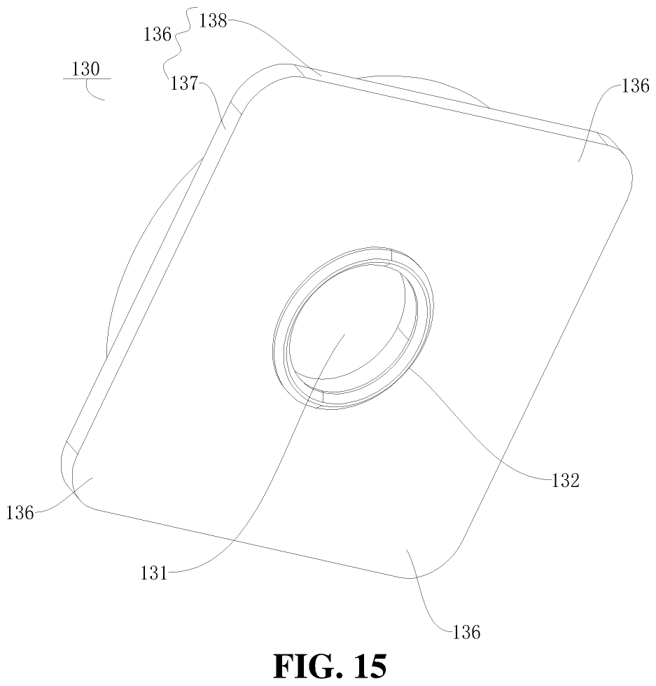

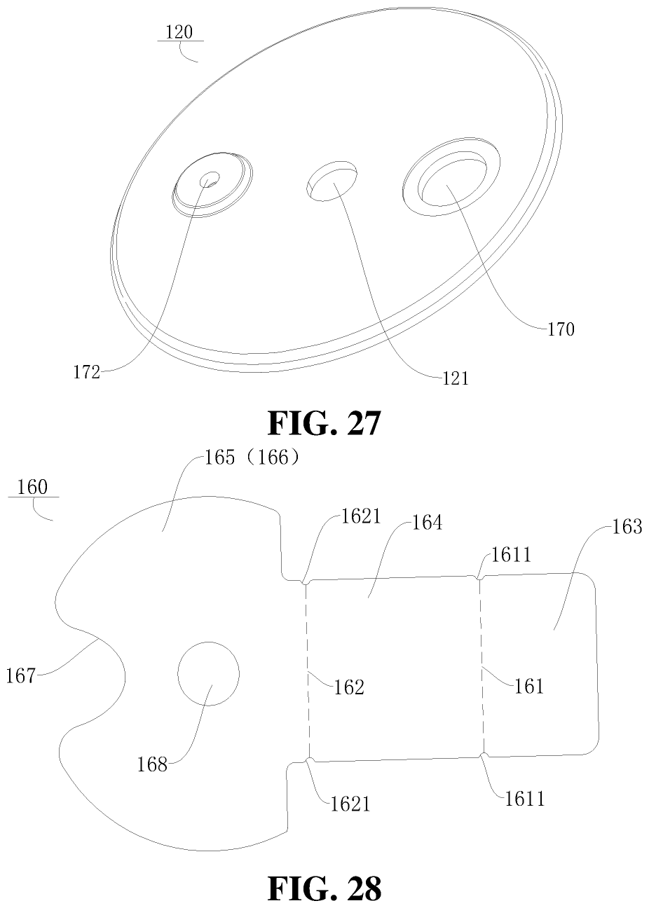

A top cover assembly 100 for a battery 1000 according to implementations of the disclosure is described hereinafter with reference to FIGS. 1-30. The top cover assembly 100 includes a current collector 160 and a pole 150. For example, the battery 1000 can be a secondary battery.

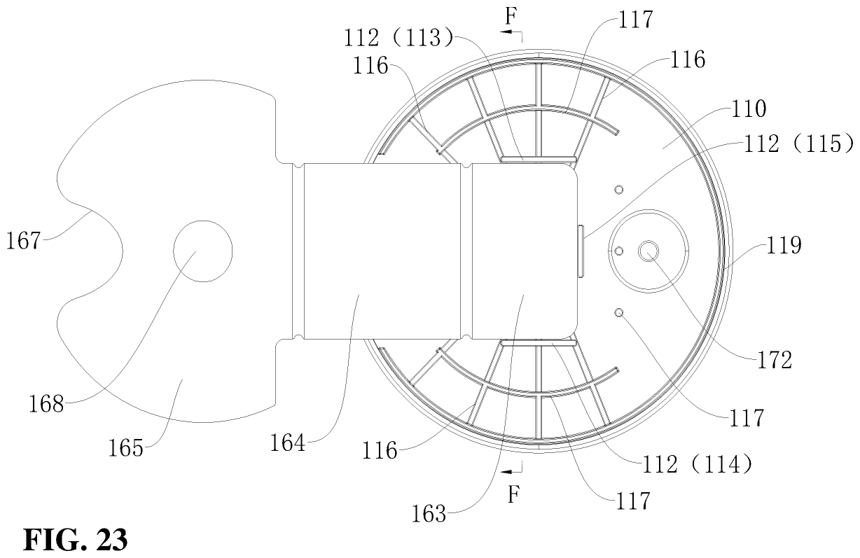

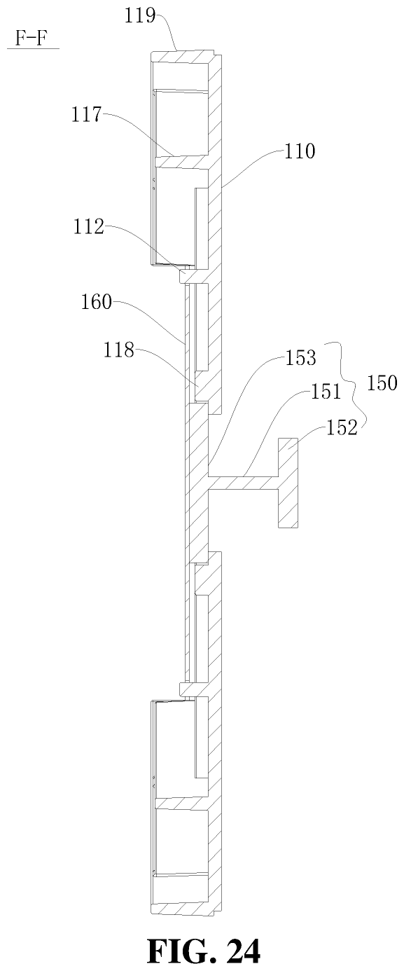

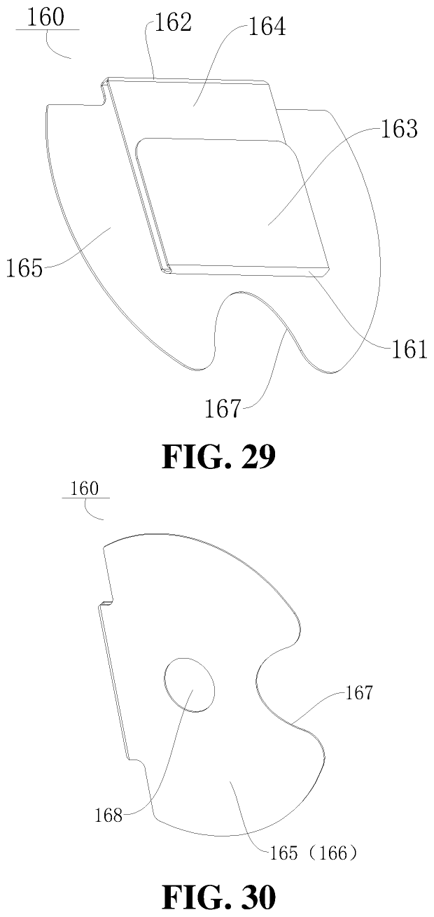

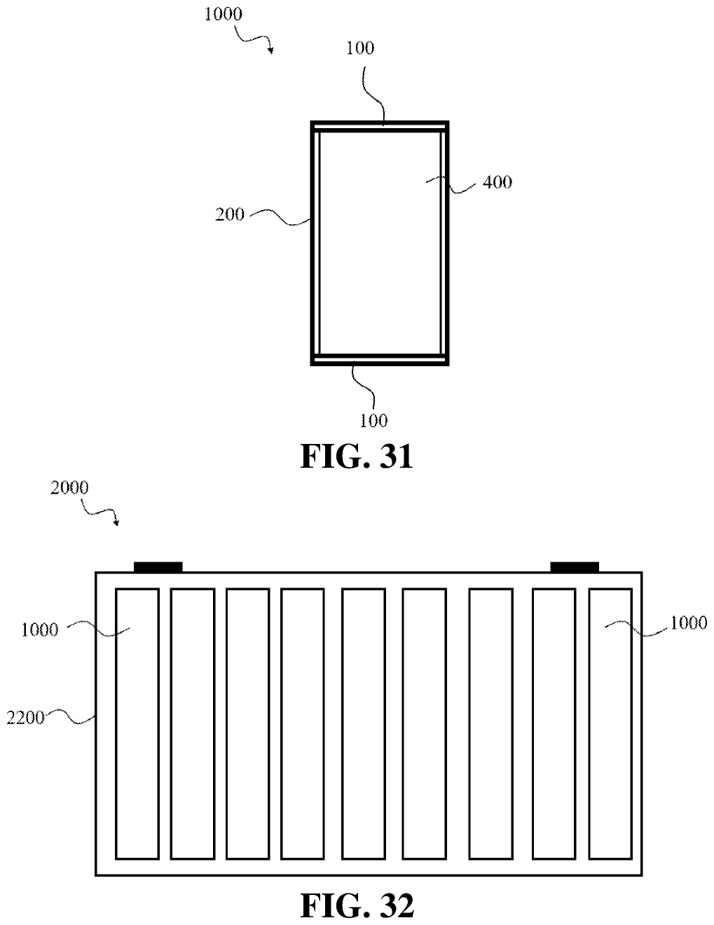

In some implementations, as illustrated in FIG. 23 and FIG. 24, the current collector has multiple folding sections. The multiple folding sections include at least a first folding section 161 and a second folding section 162. As illustrated in FIG. 28 and FIG. 29, the current collector 160 has the first folding section 161 and a second folding section 162. The first folding section 161 is spaced apart from the second folding section 162 in a length direction of the current collector 160. Both the first folding section 161 and the second folding section 162 extend in a width direction of the current collector 160. The current collector 160 is divided by the first folding section 161 and the second folding section 162 into a first part 163, a second part 164, and a third part 165. The first part 163 is bent toward one side of the second part 164 and connected with the pole 150. The third part 165 is bent toward the other side of the second part 164 and connected with a wound core of the battery 1000. For example, the first part 163 and the third part 165 are respectively connected with both ends of the second part 164 in the length direction. The current collector 160 is welded with the pole 150 and a battery core 400. The first part 163 is welded with the pole 150. The third part 165 is welded with the battery core 400. The current collector 160 may be located at one side of an insulating cover plate 110 of the top cover assembly 100 away from an insulating member 130. The top cover assembly 100 for a battery 1000 has advantages of good sealing and simple structure.

In an implementation, the current collector 160 is foldable. When the current collector 160 is folded, the first part 163 is folded along the first folding section 161 and bent towards one side of the second part 164, and the third part 165 is folded along the second folding section 162 and bent towards the other side of the second part 164. When the current collector 160 is unfolded, the current collector 160 can be in an unfolded state, and a center of the first part 163, a center of the second part 164, and a center of the third part 165 of the current collector 160 are on the same plane.

In the top cover assembly 100 for a battery 1000 according to implementations of the disclosure, when folding the current collector 160, the current collector 160 is folded in two different directions, so that the first part 163 and the third part 165 can be separated by the second part 164. As such, when connecting the first part 163 with the pole 150, influence of a welding process on the third part 165 can be reduced. Similarly, when connecting the third part 165 with a tab of a battery core 400, influence of a welding process on the first part 163 can also be reduced.

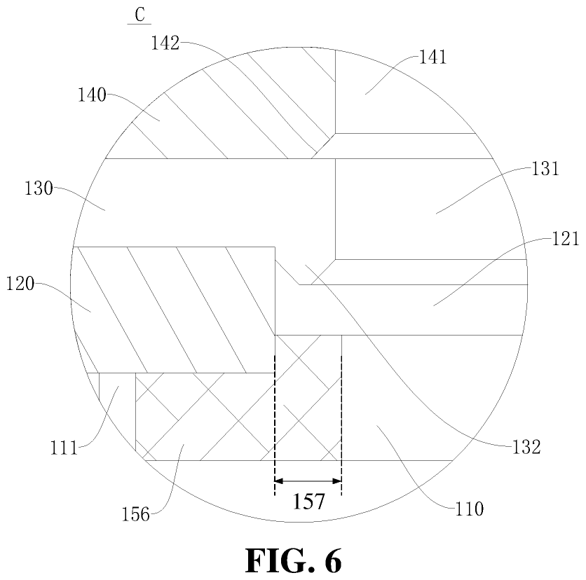

In some implementations, the top cover assembly 100 may also include the insulating cover plate 110, a top cover plate 120, the insulating member 130, and a pressing block 140. For example, the insulating cover plate 110 can be a lower plastic, the insulating member 130 can be an upper plastic. As illustrated in FIGS. 1-3, the insulating cover plate 110, the top cover plate 120, the insulating member 130, and the pressing block 140 are stacked in sequence from bottom to top. As illustrated in FIG. 5 and FIG. 6, the insulating cover plate 110 defines a mounting hole 111, the top cover plate 120 defines a through hole 121, the insulating member 130 defines a positioning hole 131, and the pressing block 140 defines a limiting hole 141. The mounting hole 111, the through hole 121, the positioning hole 131, and the limiting hole 141 are opposite to and communicate with one another in sequence to form a through hole in which the pole 150 can be mounted.

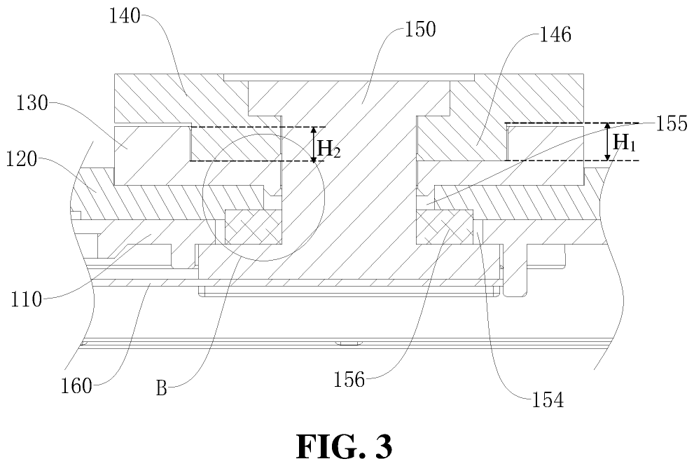

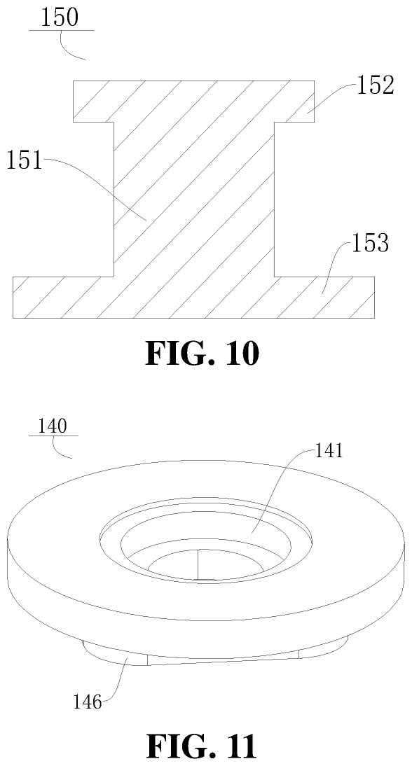

As illustrated in FIG. 3 and FIG. 10, the pole 150 can has a main body 151, a first flange 152, and a second flange 153. The main body 151 is cylindrical. The first flange 152 is located at an edge of one end of the main body 151, projects radially from the main body 151, extends in a circumferential direction of the main body 151. The second flange 153 is located at an edge of the other end of the main body 151, projects radially from the main body 151, and extends in the circumferential direction of the main body 151

In an implementation, as illustrated in FIG. 3, the main body 151 extends through the limiting hole 141, the positioning hole 131, the through hole 121, and the mounting hole 111. The pressing block 140, the insulating member 130, the top cover plate 120, and the insulating cover plate 110 are sandwiched between the first flange 152 and the second flange 153. The first flange 152 abuts against the pressing block 140. The second flange 153 abuts against the insulating cover plate 110. Here, the first flange 152 and the second flange 153 can press and fix the stacked pressing block 140, the insulating member 130, the top cover plate 120, and the insulating cover plate 110, which can improve stability of the top cover assembly 100.

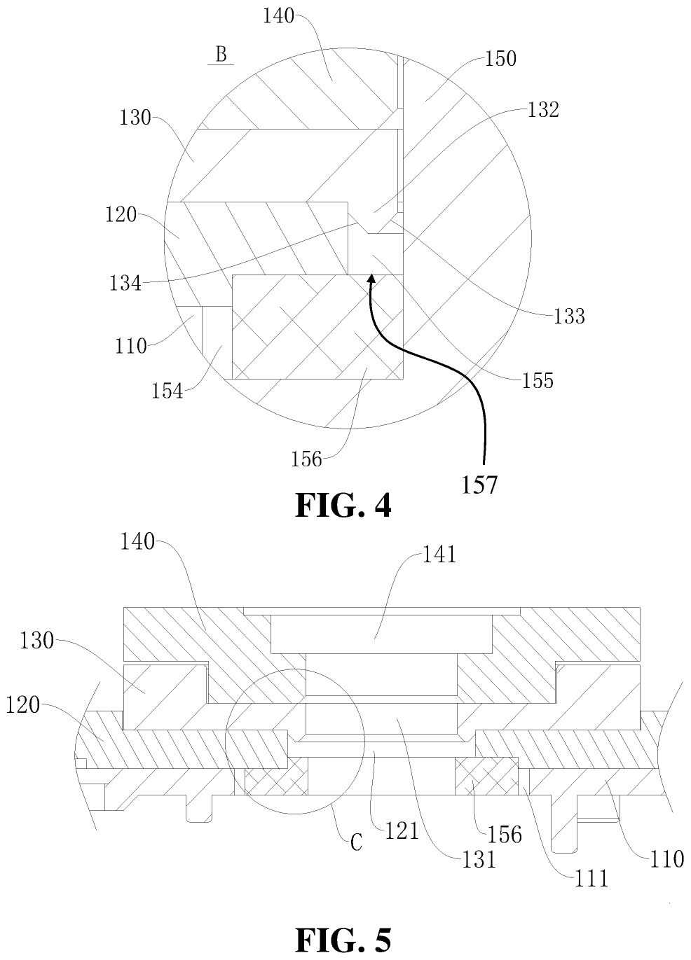

As illustrated in FIGS. 4 to 6, the through hole 121 has a hole diameter smaller than the mounting hole 111. The positioning hole 131 has a hole diameter smaller than the through hole 121. As such, a through hole constructed by the through hole 121, the mounting hole 111, and the positioning hole 131 can have multiple hole segments with different diameters. Further, a surface of the second flange 153 close to the first flange 152, an inner circumferential wall of the mounting hole 111, and a surface of the top cover plate 120 close to the second flange 153 and extending beyond the inner circumferential wall of the mounting hole 111 define a sealing cavity 154. A sealing member 156 is received in the sealing cavity 154.

In addition, in the length direction of the current collector 160, a length of the first part 163 is smaller than a length of the second part 164. As such, when the current collector 160 is folded, parts of the current collector 160 can be staggered, so that an overall thickness of the folded current collector 160 may have a stepwise change. On the one hand, the current collector 160 can be accommodated on one side of the insulating member 130. On the other hand, functional regions or avoidance structures can be set on different parts. For example, as illustrated in FIG. 28 and FIG. 30, the third part 165 has an enlarged section 166, a width of the enlarged section 166 is larger than that of the second part 164. The enlarged section 166 has an avoidance gap 167. The avoidance gap 167 can avoid explosion-proof valve. The avoidance gap 167 extends through part of an edge of the enlarged section 166. Further, the enlarged section 166 has an avoidance hole 168 opposite to one end of the pole 150.

In some implementations, as illustrated in FIG. 28, at least one of the first folding section 161 and the second folding section 162 extends along a straight line, which facilitates folding of the current collector 160. It is noted that, when the current collector 160 is folded, due to ductility of a material of the current collector 160, material accumulation is prone to occur at folding section positions. In order to solve this technical problem, in some implementations of the disclosure, as illustrated in FIG. 28, the first folding section 161 have first grooves 1611 at both ends thereof, and the second folding section 162 have second grooves 1621 at both ends thereof.

According to some implementations of the disclosure, as illustrated in FIG. 4, an inner circumferential wall of the through hole 121 and an outer circumferential wall of the main body 151 define a gap therebetween. The gap 155 communicates with the sealing cavity 154. That is, the sealing cavity 154 has an opening 157 at a position close to the gap 155, and the sealing cavity 154 communicates with the gap 155 via the opening 157. As such, when the sealing member 156 is assembled into the sealing cavity 154, an inner wall of the sealing cavity 154 extrudes the sealing member 156. Under the action of an extrusion force, part of the sealing member 156 is deformed. Since the sealing cavity 154 is in communication with the gap 155, the sealing member 156 is deformed toward an interior of the gap 155. Here, the part of the sealing member 156 can block the opening 157, which can improve the sealing effect of the sealing member 156.

As such, the sealing cavity 154 is constructed by using the pole 150, the pressing block 140, the insulating member 130, the top cover plate 120, and the insulating cover plate 110. The sealing cavity 154 is in communication with the gap 155 between the inner circumferential wall of the through hole 121 and the outer circumferential wall of the main body 151. When the sealing member 156 is assembled into the sealing cavity 154, part of the sealing member 156 can be deformed under the action of an extrusion force to block an opening 157, which improves the sealing effect of the sealing member 156.

According to some implementations of the disclosure, the mounting hole 111 has a cross-section gradually decreased in area in a direction from the second flange 153 to the first flange 152. It can be noted that for the mounting hole 111, the cross-section thereof is gradually decreased in area, so that a circumferential wall of the mounting hole 111 can be structured into an inclined circumferential wall. When the sealing member 156 is assembled into the mounting hole 111, the inclined circumferential wall has an extrusion effect on the sealing member 156, which can drive the sealing member 156 to deform toward the gap 155, thereby improving the sealing effect of the sealing member 156.

In an example illustrated in FIG. 13 and FIG. 6, the limiting hole 141 has a first chamfer 142 on an end of the limiting hole 141 close to the insulating member 130. On the one hand, with aid of a chamfering structure, a cutting stress during processing the pressing block 140 can be eliminated, which can improve structural strength of the pressing block 140. On the other hand, when assembling the pole 150, with aid of the first chamfer 142 which acts as a guide, the pole 150 can be guided to extend through the limiting hole 141.

According to some implementations of the disclosure, as illustrated in FIG. 13, the limiting hole 141 has a first hole section 143, a second hole section 144, and a third hole section 145 which communicate in sequence. In an implementation, the first flange 152 is received in the second hole section 144. Part of the main body 151 is received in the third hole section 145. It is noted that, the second hole section 144 and the third hole section 145 can be used to receive the pole 150. The first hole section 143 has a radial size larger than the second hole section 144. In a case that an end of the pole 150 in the second hole section 144 needs to be soldered, an inner space of the first hole section 143 can be used to accommodate solder. In a case that the end of the pole 150 in the second hole section 144 needs to be riveted, the end of the pole 150 will deform to generate a protrusion after riveting, and the inner space of the first hole section 143 can be used for receiving the protrusion.

Further, as illustrated in FIG. 3, a surface of the first flange 152 away from the second flange 153 is flush with an inner bottom wall of the first hole section 143. As such, it is convenient to weld or rive the pole 150, and the pole 150 will not occupy the inner space of the first hole section 143. Therefore, the first hole section 143 can accommodate solder or a riveting protrusion of the pole 150 to prevent the solder from overflowing or prevent the protrusion from extending beyond a surface of the pressing block 140.

According to some implementations of the disclosure, as illustrated in FIGS. 3, 13, and 17, the pressing block 140 has a fitting protrusion 146 on a side of the pressing block 140 facing towards the insulating member 130. The insulating member 130 defines a fitting recess 135 on a side of the insulating member 130 facing towards the pressing block 140. The fitting protrusion 146 is embedded in the fitting recess 135. A height of the fitting protrusion 146 extending beyond the surface of the pressing block 140 is H₁, and a depth of the fitting recess 135 is H₂, where H₁>H₂. That is, the height of the fitting protrusion 146 is larger than the height of the fitting recess 135. As such, when the fitting protrusion 146 is embedded in the fitting recess 135, the fitting protrusion 146 will support the entire pressing block 140 so that the rest of the pressing block 140 other than the fitting protrusion 146 is spaced apart from the insulating member 130. Under the action of an assembly force of the top cover assembly 100, the fitting protrusion 146 will be in close contact with an inner bottom wall of the fitting recess 135, thereby improving sealing between the pressing block 140 and the insulating member 130. In order to prevent a relative rotation between the pressing block 140 and the insulating member 130, in some implementations, the fitting recess 135 is square.

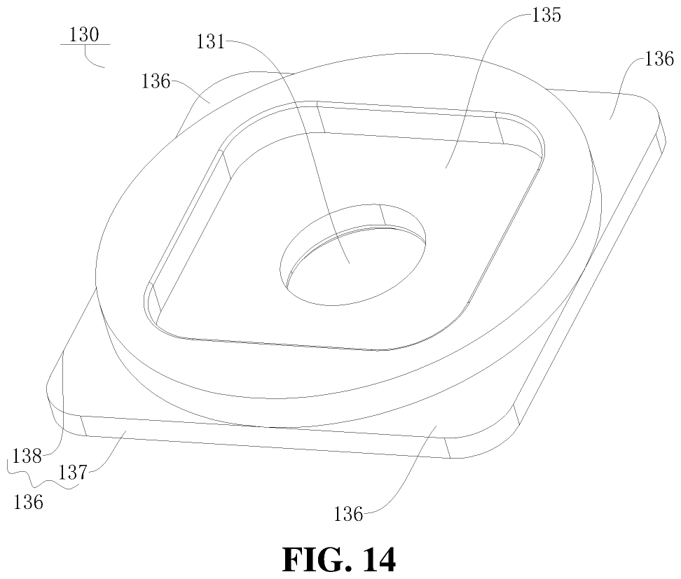

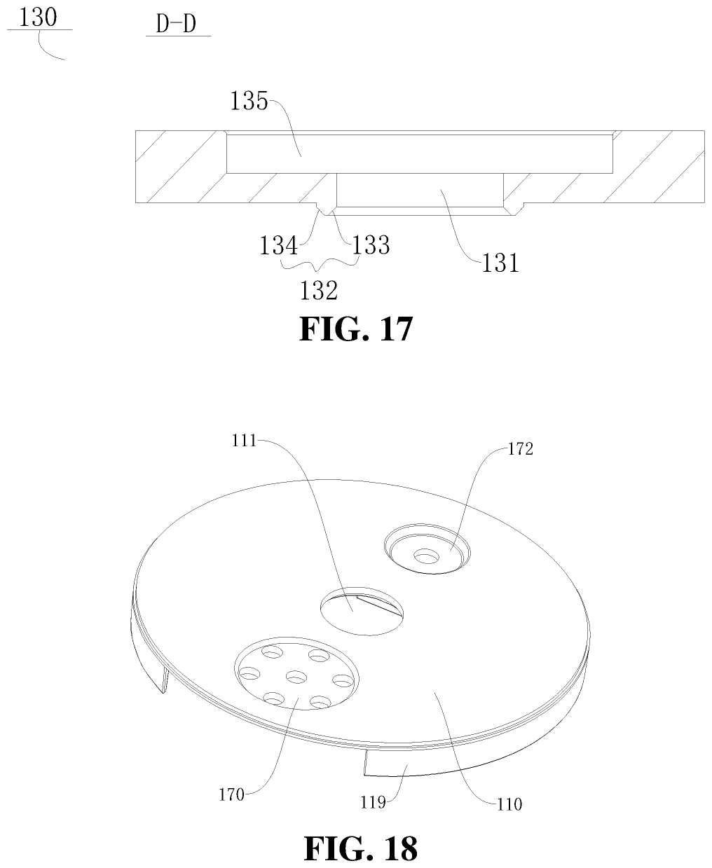

According to some implementations of the disclosure, as illustrated in FIGS. 14-16, the insulating member 130 has a boss 132 on a side of the insulating member 130 close to the top cover plate 120. The positioning hole 131 extends through the boss 132. The boss 132 is received in the through hole 121. As such, during assembly, the boss 132 can be received in the through hole 121 for pre-positioning, which facilitates assembling of the insulating member 130 and the top cover plate 120. Further, as illustrated in FIG. 17, the boss 132 has a second chamfer 133 between an end surface of the boss 132 and an inner circumferential wall of the positioning hole 131. The boss 132 has a third chamfer 134 between an end surface and an outer circumferential wall of the boss 132.

It is noted that the boss 132 has chamfered structures at an end corner of the boss 132 in a radial direction. On the one hand, with aid of the chamfering structures, a cutting stress during processing of the pressing block 140 can be eliminated, which can improve structural strength of the pressing block 140. On the other hand, with aid of the third chamfer 134 which acts as a guide, the boss 132 can be guided into the through hole 121 during assembly, and with aid of the second chamfer 133 which acts as a guide, the pole 150 can be guided to be received in the positioning hole 131.

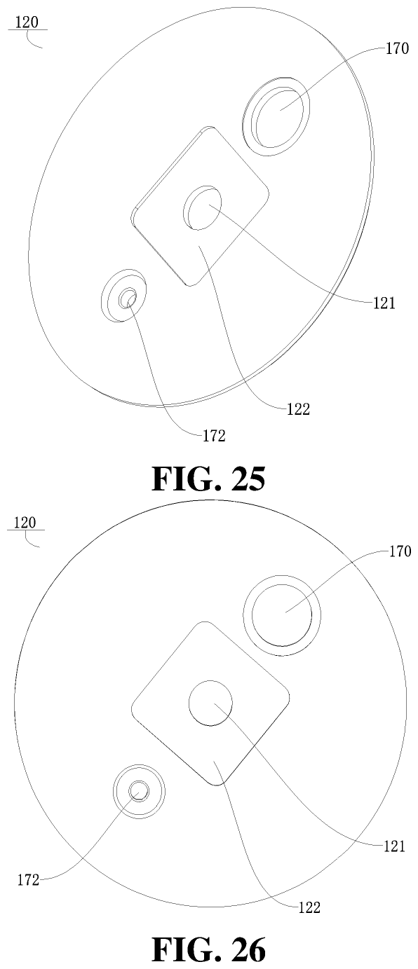

According to some implementations of the disclosure, as illustrated in FIG. 25 and FIG. 26, the top cover plate 120 defines an anti-rotation recess 122. The through hole 121 extends through a bottom of the anti-rotation recess 122. As illustrated in FIGS. 14-16, the insulating member 130 has an anti-rotation flange 136 on a circumferential wall of the insulating member 130. The anti-rotation flange 136 is embedded in the anti-rotation recess 122. Thus, when the insulating member 130 is assembled with the top cover plate 120, the anti-rotation flange 136 has a limiting effect on the insulating member 130 in the circumferential direction of the through hole 121, which can prevent the insulating member 130 from rotating relative to the top cover plate 120.

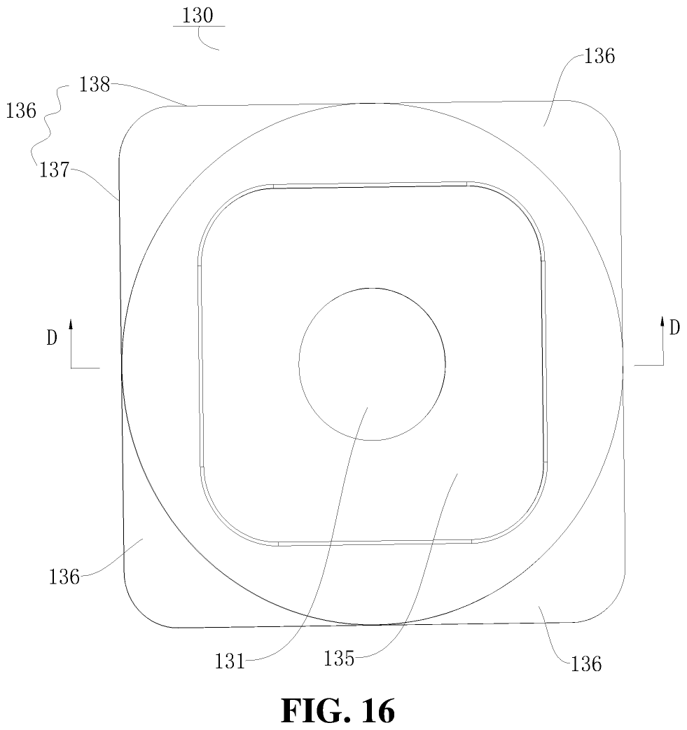

Further, as illustrated in FIGS. 14-16, the anti-rotation flange 136 includes a first anti-rotation edge 137 and a second anti-rotation edge 138. The first anti-rotation edge 137 and the second anti-rotation edge 138 define an included angle. The included angle may be 90°. An intersection of the first anti-rotation edge 137 and the second anti-rotation edge 138 has a smooth transition. Here, it is noted that, as illustrated in FIG. 16, when the insulating member 130 has a tendency to rotate clockwise, the second anti-rotation edge 138 can abut against an inner circumferential wall of the anti-rotation recess 122 to prevent rotation. When the insulating member 130 has a tendency to rotate counterclockwise, the first anti-rotation edge 137 can abut against the inner circumferential wall of the anti-rotation recess 122 to prevent rotation. In order to improve an anti-rotation effect, in some examples, the anti-rotation flange 136 includes multiple anti-rotation flanges 136 spaced apart in a circumferential direction of the insulating member 130. Further, the anti-rotation recess 122 may be square.

In some implementations, as illustrated in FIG. 25 and FIG. 26, the top cover assembly 100 defines an explosion-proof hole 170 and a liquid-injection hole 172. It is noted here that the battery 1000 includes the top cover assembly, a battery core 400, and a cylindrical hard case 200. One end of the hard case 200 is closed, and the other end of the hard case 200 is open. The top cover assembly 100 can be disposed on the open end of the hard case 200 to seal the hard case 200. The battery core 400 is disposed inside the hard case 200. The explosion-proof hole 170 extends through the top cover plate 120 and the insulating cover plate 110 in sequence, and communicates with the interior of the hard case 200. Similarly, the liquid-injection hole 172 extends through the top cover plate 120 and the insulating cover plate 110 in sequence, and communicates with the interior of the hard case 200. In order to improve safety of the battery 1000, an explosion-proof valve 171 may be disposed at the explosion-proof hole 170. In order to ensure sealing of the battery 1000, after the liquid injection process, the liquid-injection hole 172 can be sealed by a liquid-injection-hole plug 173.

According to some implementations of the disclosure, the insulating cover plate 110 has multiple limiting ribs 112 on one side of the insulating cover plate 110 away from the top cover plate 120. The multiple limiting ribs 112 define a clamping groove, which defines a mounting position of the current collector 160. It is noted that, when welding the current collector 160 and the pole 150, a relative position between the current collector 160 and the pole 150 needs to be determined. By defining the clamping groove with the limiting ribs 112 and positioning the current collector 160 with the clamping groove, assembling the current collector 160 can be facilitated.

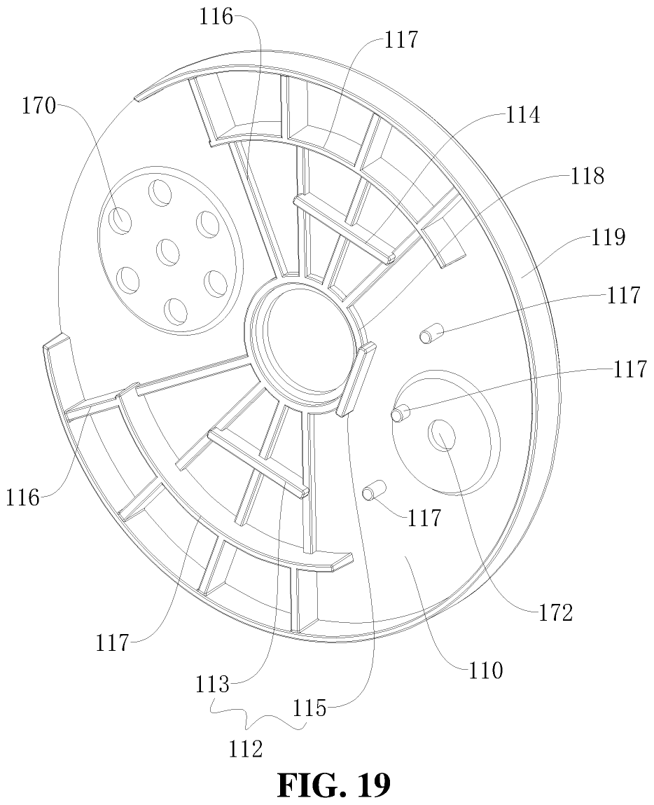

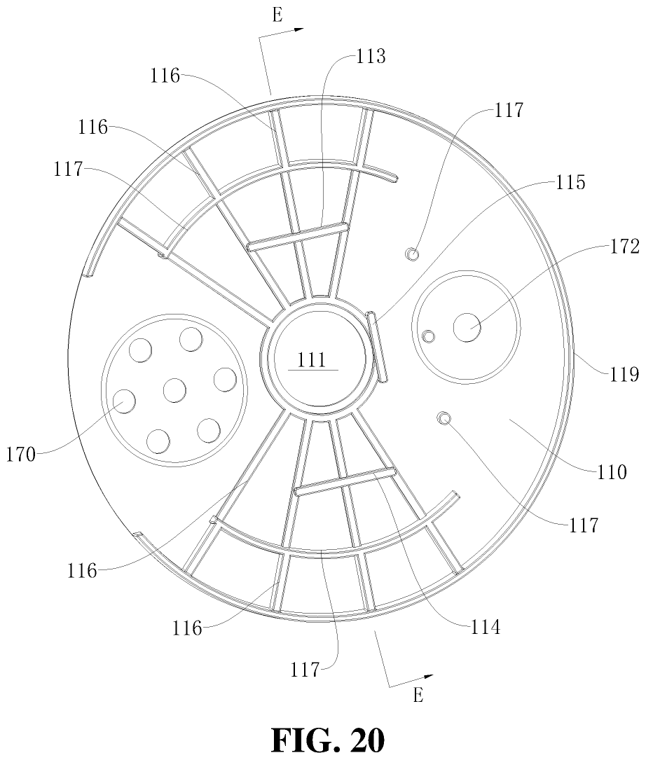

An arrangement of the limiting ribs 112 is not limited herein, as long as it can limit the current collector 160. For example, in some examples, as illustrated in FIG. 19, FIG. 20, and FIG. 23, the limiting rib 112 may be three limiting ribs 112, which include a first limiting rib 113, a second limiting rib 114, and a third limiting rib 115. The first limiting rib 113 is parallel to and opposite to the second limiting rib 114. The current collector 160 is between the first limiting rib 113 and the second limiting rib 114, that is, between two parallel limiting ribs 112. The third limiting rib 115 is located at an end of the current collector 160, and the third limiting rib 115 is parallel to an edge of the end of the current collector 160. The third limiting rib 115 is perpendicular to the first limiting rib 113.

Further, in order to strengthen structural strength of the insulating cover plate 110, as illustrated in FIG. 19 and FIG. 20, one side of the insulating cover plate 110 away from the top cover plate 120 has multiple reinforcing ribs 116. In an implementation, the multiple reinforcing ribs 116 are arranged radially with the mounting hole 111 as the center of a circle. Furthermore, at least one of the reinforcing ribs 116 intersects with the limiting rib 112 to form a cross-rib structure, and the cross-rib structure can further improve the structural strength of the top cover plate 120.

According to some implementations of the disclosure, as illustrated in FIGS. 20-22, the insulating cover plate 110 has an abutment portion 117 on one side of the insulating cover plate 110 away from the top cover plate 120. The abutment portion 117 supports the current collector 160. It is noted that the current collector 160 can be accommodated on one side of the insulating cover plate 110 by folding. During assembling the top cover assembly 100, the assembly force exerts a pressing effect on the current collector 160. With aid of the abutment portion 117, the current collector 160 can be supported and protected. Further, the abutment portion 117 may be in a long-strip shape. The abutment portion 117 may extend to have a shape similar to an edge of the current collector 160. For example, the current collector 160 may be an arc-shaped rib. Further, as illustrated in FIG. 20, two abutment portions 117 symmetrically distributed with respect to the mounting hole 111. It is noted here that the shape of the abutment portion 117 is not limited herein. For example, in some implementations, the abutment portion 117 is cylindrical, and multiple abutment portions 117 are arranged at intervals.

In order to improve assembly stability of the pole 150, in some implementations, the insulating cover plate 110 has a protective flange 118 on one side of the insulating cover plate 110 away from the top cover plate 120. The protective flange 118 surrounds an outer circumference of the pole 150. As such, a contact area between the inner circumferential wall of the mounting hole 111 and the pole 150 can be increased, and the pole 150 can be protected and supported by the protective flange 118 to prevent the pole 150 from being deformed or inclined. In addition, the protective flange 118 can increase the structural strength of the insulating cover plate 110, that is, the protective flange 118 can act as the reinforcing rib 116 to increase the structural strength of the insulating cover plate 110.

As illustrated in FIG. 18, according to some implementations of the disclosure, the insulating cover plate 110 has a bending edge 119 on one side of the insulating cover plate 110 away from the top cover plate 120. The bending edge 119 is located at an edge of the insulating cover plate 110 and extends in a circumferential direction of the insulating cover plate 110. On the one hand, the bending edge 119 can increase the structural strength of the insulating cover plate 110. On the other hand, with the bending edge 119, a substantially closed receiving space can be formed to accommodate the current collector 160 and protect the current collector 160 from being squeezed and collided.

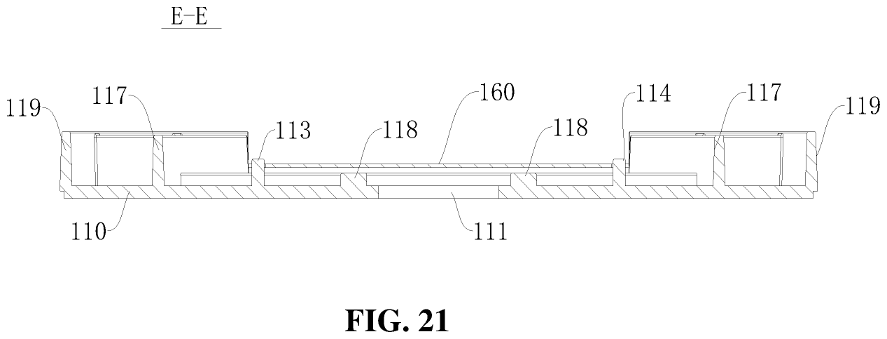

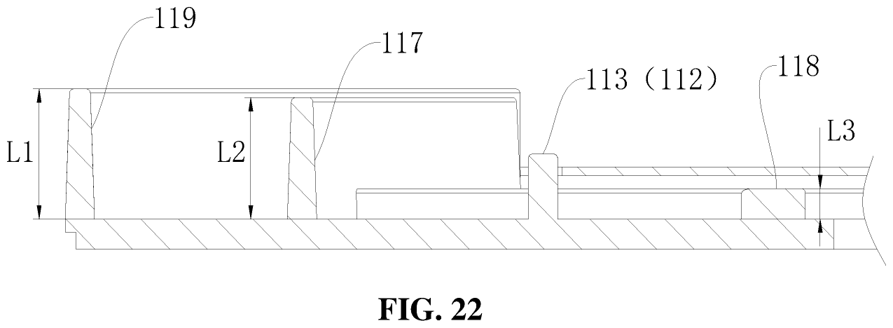

In order to better accommodate the current collector 160, in some implementations, as illustrated in FIG. 21 and FIG. 22, a height of the bending edge 119 is larger than a height of the abutment portion 117. As such, a height difference between the bending edge 119 and the abutment portion 117 can define a reserved space, and part of the current collector 160 can be accommodated in the reserved space. It is noted that, when the current collector 160 is assembled with the insulating cover plate 110, the current collector 160 needs to be folded. Due to different layers of folding, the current collector 160 has different thicknesses at different regions. In order to better accommodate the folded current collector 160, in some implementations, as illustrated in FIG. 21 and FIG. 22, the height of the abutment portion 117 is larger than the height of the protective flange 118. As such, a height difference between the abutment portion 117 and the protective flange 118 can also define a reserved space to accommodate the current collector 160. For example, as illustrated in FIG. 22, the height of the bending edge 119 is L1, the height of the abutment portion 117 is L2, and the height of the protective flange 118 is L3, where L1>L2>L3.

In order to better protect the current collector 160, in some implementations, the height difference between the bending edge 119 and the protective flange 118 is larger than a thickness of a space occupied by the current collector 160. As such, the current collector 160 can be completely accommodated in the reserved space defined by the bending edge 119 and the abutment portion 117.

A battery 1000 according to the implementations of the disclosure includes a case 200, a top cover assembly 100 covering the case 200, and a battery core 400 received in the case 200. The battery core 400 is electrically coupled with the top cover assembly 100. The top cover assembly 100 for a battery 1000 as described above. It is noted that the battery 1000 can be a single cell, and multiple single-cells can be assembled into a battery pack, an energy storage device 2000, or a charging station. In an implementation, the case 200 is a cylindrical hard case 200. One end of the hard case 200 is closed, and the other end of the hard case 200 is open. The top cover assembly 100 can be arranged at the open end of the hard case 200 to seal the hard case 200. The battery core 400 is disposed inside the hard case 200.

In the battery 1000 according to the implementations of the disclosure, when folding the current collector 160, the current collector 160 is folded in two different directions, so that the first part 163 and the third part 165 can be separated by the second part 164 when the current collector 160 is folded. As such, when welding the first part 163 with the pole 150, influence of a welding process on the third part 165 can be reduced. Similarly, when welding the third part 165 with a tab of a battery core 400, influence of a welding process on the first part 163 can also be reduced.

An energy storage device 2000 according to the implementations of the disclosure includes a housing 2200 and multiple above-mentioned battery 1000. The multiple batteries 1000 are received in the housing 2200. In the energy storage device 2000 according to the implementations of the disclosure, when folding the current collector 160, the current collector 160 is folded in two different directions, so that the first part 163 and the third part 165 can be separated by the second part 164. As such, when welding the first part 163 with the pole 150, influence of a welding process on the third part 165 can be reduced. Similarly, when welding the third part 165 with a tab of a battery core 400, influence of a welding process on the first part 163 can also be reduced.

In the description of the disclosure, descriptions with reference to terms such as “one implementation”, “some implementations”, “examples”, “specific examples”, or “some examples” mean that specific features, structures, materials, or characteristics described in combination with the implementations or examples are included in at least one implementation or example of the disclosure. The schematic expressions of the above terms herein do not necessarily refer to the same implementation or example.

Although the implementations of the disclosure have been illustrated and described, it is appreciated by those of ordinary skill in the art that various variations, modifications, replacements, and variants of these implementations can be made without departing from the principles and purposes of the disclosure, the scope of disclosure is defined by the claims and their equivalents.

What is claimed is:

1. A top cover assembly for a battery, comprising:
a pole; and
a current collector having a plurality of folding sections, wherein
the plurality of folding sections comprise at least a first folding section and a second folding section, the first folding section being spaced apart from the second folding section in a length direction of the current collector; and
the current collector is divided by the first folding section and the second folding section into a first part, a second part, and a third part, the first part being bent toward one side of the second part and connected with the pole, and the third part being bent toward the other side of the second part and connected with a wound core of the battery.

2. The top cover assembly for a battery of claim 1, wherein at least one of the first folding section or the second folding section extends straight.

3. The top cover assembly for a battery of claim 2, wherein the first part has a length larger than the second part in the length direction of the current collector.

4. The top cover assembly for a battery of claim 1, further comprising:
an insulating cover plate defining a mounting hole;
a top cover plate stacked with the insulating cover plate and defining a through hole, the through hole being opposite to the mounting hole and having a diameter smaller than the mounting hole; and
an insulating member stacked with one side of the top cover plate away from the insulating cover plate, the insulating member defining a positioning hole, the positioning hole being opposite to the through hole and having a diameter smaller than the through hole.

5. The top cover assembly for a battery of claim 4, further comprising:
a pressing block disposed on one side of the insulating member away from the top cover plate, the pressing block defining a limiting hole opposite to the positioning hole;
the pole has a main body, a first flange, and a second flange, the first flange being located at an edge of one end of the main body, projecting radially from the main body, and extending in a circumferential direction of the main body, and the second flange being located at an edge of the other end of the main body, projecting radially from the main body, and extending in the circumferential direction of the main body; and
the limiting hole has a first hole section, a second hole section, and a third hole section which communicate in sequence, the first hole section has a radial size larger than the second hole section, the first flange is received in the second hole section, and part of the main body is received in the third hole section.

6. The top cover assembly for a battery of claim 5, wherein the pressing block has a fitting protrusion on one side of the pressing block facing towards the insulating member, the insulating member defines a fitting recess on one side of the insulating member facing towards the pressing block, and the fitting protrusion is embedded in the fitting recess.

7. The top cover assembly for a battery of claim 6, a height of the fitting protrusion is H₁, and a depth of the fitting recess is H₂, wherein H₁>H₂.

8. The top cover assembly for a battery of claim 4, wherein
the top cover plate defines an anti-rotation recess, the through hole being defined in the anti-rotation recess; and
the insulating member has an anti-rotation flange on a circumferential wall of the insulating member, the anti-rotation flange being embedded in the anti-rotation recess.

9. A battery, comprising a case, a top cover assembly covering the case, and a battery core received in the case and electrically coupled with the top cover assembly, wherein the top cover assembly comprises:
a pole; and
a current collector having a plurality of folding sections, wherein
the plurality of folding sections comprise at least a first folding section and a second folding section, the first folding section being spaced apart from the second folding section in a length direction of the current collector; and
the current collector is divided by the first folding section and the second folding section into a first part, a second part, and a third part, the first part being bent toward one side of the second part and connected with the pole, and the third part being bent toward the other side of the second part and connected with a wound core of the battery.

10. The battery of claim 9, wherein at least one of the first folding section or the second folding section extends straight.

11. The battery of claim 10, wherein the first part has a length larger than the second part in the length direction of the current collector.

12. The battery of claim 9, further comprising:
an insulating cover plate defining a mounting hole;
a top cover plate stacked with the insulating cover plate and defining a through hole, the through hole being opposite to the mounting hole and having a diameter smaller than the mounting hole; and
an insulating member stacked with one side of the top cover plate away from the insulating cover plate, the insulating member defining a positioning hole, the positioning hole being opposite to the through hole and having a diameter smaller than the through hole.

13. The battery of claim 12, further comprising:
a pressing block disposed on one side of the insulating member away from the top cover plate, the pressing block defining a limiting hole opposite to the positioning hole;
the pole has a main body, a first flange, and a second flange, the first flange being located at an edge of one end of the main body, projecting radially from the main body, and extending in a circumferential direction of the main body, and the second flange being located at an edge of the other end of the main body, projecting radially from the main body, and extending in the circumferential direction of the main body; and
the limiting hole has a first hole section, a second hole section, and a third hole section which communicate in sequence, the first hole section has a radial size larger than the second hole section, the first flange is received in the second hole section, and part of the main body is received in the third hole section.

14. The battery of claim 13, wherein the pressing block has a fitting protrusion on one side of the pressing block facing towards the insulating member, the insulating member defines a fitting recess on one side of the insulating member facing towards the pressing block, and the fitting protrusion is embedded in the fitting recess.

15. The battery of claim 14, a height of the fitting protrusion is H₁, and a depth of the fitting recess is H₂, wherein H₁>H₂.

16. The battery of claim 12, further comprising a top cover plate stacked with the insulating cover plate, wherein
the top cover plate defines an anti-rotation recess, the through hole being defined in the anti-rotation recess; and
the insulating member has an anti-rotation flange on a circumferential wall of the insulating member, the anti-rotation flange being embedded in the anti-rotation recess.

17. An energy storage device, comprising a housing and a plurality of batteries received in the housing, wherein each of the plurality of batteries comprises a case, a top cover assembly covering the case, and a battery core received in the case and electrically coupled with the top cover assembly, and the top cover assembly comprises:
a pole; and
a current collector having a plurality of folding sections, wherein
the plurality of folding sections comprise at least a first folding section and a second folding section, the first folding section being spaced apart from the second folding section in a length direction of the current collector; and
the current collector is divided by the first folding section and the second folding section into a first part, a second part, and a third part, the first part being bent toward one side of the second part and connected with the pole, and the third part being bent toward the other side of the second part and connected with a wound core of the battery.

18. The energy storage device of claim 17, wherein at least one of the first folding section or the second folding section extends straight.

19. The energy storage device of claim 18, wherein the first part has a length larger than the second part in the length direction of the current collector.

20. The energy storage device of claim 17, further comprising:
an insulating cover plate defining a mounting hole;
a top cover plate stacked with the insulating cover plate and defining a through hole, the through hole being opposite to the mounting hole and having a diameter smaller than the mounting hole; and
an insulating member stacked with one side of the top cover plate away from the insulating cover plate, the insulating member defining a positioning hole, the positioning hole being opposite to the through hole and having a diameter smaller than the through hole.
